(19) United States
(12) Patent Application Publication
(10) Pub. No.: US 2008/0054169 A1
(43) Pub. Date: Mar. 6, 2008

(54) OPTICAL ENCODER

(76) Inventor: Norikazu OKADA, Kashihara-shi (JP)

Correspondence Address: BIRCH STEWART KOLASCH & BIRCH, PO BOX 747, FALLS CHURCH, VA, 22040-0747, US

(21) Appl. No.: 11/850,442

(22) Filed: Sep. 5, 2007

(30) Foreign Application Priority Data
Sep. 6, 2006 (JP) P2006-241536

(51) Int. Cl. G01D 5/34

(52) U.S. Cl. 250/231.13

(57) ABSTRACT

An optical encoder has subtracters serving as signal processing circuits, adders serving as an arithmetic processing section, comparators serving as an A/D converting section, exclusive-or circuits, and output circuits as a digital signal section. Two signals, A1+ and A1−, different in phase by 180 degrees from each other are input to a subtracter, which has an adjustable resistor whose resistance is adjustable. Adjustment of the resistance of the adjustable resistor reduces the DC offset of a signal, {(A1+)−(A1−)}, and a signal, {(A1−)−(A1+)}.

This nonprovisional application claims priority under 35 U.S.C. §119(a) on Patent Application No. 2006-241536 filed in Japan on Sep. 6, 2006, the entire contents of which are hereby incorporated by reference.

### BACKGROUND OF THE INVENTION

The present invention relates to an optical encoder for detecting the position, the speed of movement, the direction of movement, and the like of a movable member by using light-receiving elements. Such an optical encoder is suitable for use in, for example, copying machines, printing equipment such as printers, FA equipment, and the like.

In a conventional optical encoder, a resistor the resistance value of which is adjustable is used as a resistor connected in series to a light-emitting element to set a direct-current bias voltage so as to be able to adjust a photocurrent, thereby reducing the variations in the threshold level of a signal processing circuit (see JP 8-68666 A).

However, when this optical encoder is used in, for example, an ink jet printer or the like, if the movable member is stained with ink mist or the like, the amount of received light is reduced, so that the SN ratio is reduced and the operational accuracy is deteriorated. On the other hand, when the signal amplification factor is increased in order to compensate for a reduction in the amount of received light, the duty ratio of a signal may vary.

### SUMMARY OF THE INVENTION

It is therefore an object of the present invention to provide an optical encoder which is able to avoid deterioration of the operational accuracy in spite of variations in the amount of received light, the characteristic of which varies in a small range, and which is able to achieve an accurate and stable operation.

In order to accomplish the above object, an optical encoder according to the present invention comprises:

a light-emitting element;

a plurality of light-receiving elements arranged in one direction in an area where light from the light-emitting element is able to reach the light-receiving elements;

a movable member which has a light-on section allowing the light to enter the light-receiving elements when passing through predetermined positions corresponding to the light-receiving elements, and a light-off section not allowing the light to enter the light-receiving elements when passing through the predetermined positions corresponding the light receiving elements, wherein the light-on section and the light-off section pass through the predetermined positions alternately when the movable member moves in the one direction;

a signal processing section to which signals outputted from the plurality of light-receiving elements are input and which includes a comparison circuit for comparing two of a plurality of signals obtained from the inputted signals, said two signals being different in phase by 180 degrees from each other; and

at least one adjustable resistor for adjusting a potential of an output signal of the comparison circuit or a potential of a signal obtained from the output signal of the comparison circuit.

According to this invention, the signal processing section is able to amplify signals obtained from the light receiving elements through comparison, by the comparison circuit, of two signals which are different in phase by 180 degrees from each other. In other words, signals caused by minute photocurrents can be amplified.

The amplified signals may vary in duty ratios corresponding to the light-on section and the light-off section of the movable member by influence of the offset of the optical system from the light emitting element to the light receiving elements and the offset of the circuit system for processing signals from the light receiving elements.

In this invention, the influence of the offsets can be reduced by adjusting, with the adjustable resistor, the potential of the output signal of the comparison circuit or the potential of a signal obtained from the output signal of the comparison circuit, but not adjusting minute photocurrents which are difficult to be handled with the adjustable resistor. As a result, variations in the duty ratio of the output signal can be reduced, and thereby an accurate and stable encoder operation can be achieved.

An example of a method of adjusting the resistance value of the adjustable resistor is Zener zap trimming. In Zener zap trimming, part of the adjustable resistor is divided into a plurality of resistor sections, and Zener diodes are provided in parallel with the resistor sections. The resistance values of the adjustable resistors are adjusted by supplying current pulses to the Zener diodes to break and short-circuit them. Since the ends of the adjustable resistors need pads, it is desirable that the adjustable resistor is installed in the amplifying section for amplifying photocurrents from the light-receiving elements of the signal processing section, because the number of signals to be processed is increased in the arithmetic processing section and the like in a stage subsequent to the amplifying section, so that when the adjustable resistors are installed in the arithmetic processing section and the like in the subsequent stage, the number of necessary pads is increased.

In one embodiment, the signal processing section includes n signal processing circuits, wherein n is an integer of 2 or more, the optical encoder further includes an arithmetic processing section to which n output signals from the n signal processing circuits are input and which performs arithmetic processing on the n output signals, and the arithmetic processing section includes the adjustable resistor.

In the optical encoder of this embodiment, the arithmetic processing section includes the adjustable resistor the resistance value of which is adjustable. Thus, when analog signals are arithmetically processed in the arithmetic processing section, varying amplitude values and waveforms can be adjusted, which is beneficial to an accurate signal processing.

In one embodiment, the signal processing section includes the adjustable resistor.

In the optical encoder of this embodiment, the signal processing section includes the adjustable resistor, so that the number of adjustable resistors required can be reduced as compared with a case that the arithmetic processing section or the like in a stage subsequent to the signal processing section include the adjustable resistors. In other words, when the adjustable resistors are installed in a former stage for signal processing, sharing of the adjustable resistors can be achieved and thereby variations in resistance adjustment can be reduced and cost down can be achieved more than when the adjustable resistors are installed in a later stage for signal processing. For example, light from the light-emitting element is distributed with a gradient, so that when the adjustable resistors are installed in correspondence with the distribution of the light, the number of adjustable resistors can be reduced.

In one embodiment, the optical encoder further includes an A/D converting section for A/D converting an output signal of the arithmetic processing section, the A/D converting section including an adjustable resistor for adjusting a duty ratio.

In the optical encoder of this embodiment, the A/D converting section is able to adjust the duty ratio of a signal with the adjustable resistor, thereby reducing the influence of the offsets of the optical system and circuit system. In general, the movable member used in the optical encoder includes the light-on section and the light-off section at a ratio of 1 to 1, so that it is desirable that the duty ratio of a signal is 50%. For this reason, it is beneficial that the adjustment of the duty ratio of a signal becomes possible by the A/D (analog-to-digital) converting section including the adjustable resistor.

In one embodiment, the optical encoder further includes an A/D converting section for A/D converting an output signal of the arithmetic processing section, the A/D converting section including an adjustable resistor for adjusting a hysteresis width.

In the optical encoder of this embodiment, the hysteresis width in which a digital signal changes from the H level to the L level or from the L level to the H level is adjusted by the adjustable resistor included in the A/D converting section, so that the duty ratio of the digital signal can be adjusted. In other words, when any offset of the optical system or the circuit system has occurred, it is prevented that either of the H (high) period or the L (low) period of a digital signal becomes longer than the other one, and thereby it is prevented that the duty ratio of the digital signal deviates from an ideal state.

In one embodiment, the optical encoder further includes a digital signal section for processing a digital signal obtained from an output signal of the arithmetic processing section, the digital signal section including at least one of an adjustable resistor or an adjustable capacitance for adjusting at least one of a rise time or a fall time of the digital signal.

In the optical encoder of this embodiment, the adjustable resistor or the adjustable capacitance of the digital signal section adjusts at least one of the rise time or the fall time of a digital signal, so that the duty ratio of the digital signal can be adjusted, and thereby variations in the duty ratio of the digital signal can be reduced.

Electronic equipment according to an embodiment includes the above-described optical encoder.

Since the electronic equipment of this embodiment comprises a steady optical encoder which has an excellent operational accuracy and a few variations in the output signal also when the amount of received light varies, the operation accuracy of the electronic equipment can be increased.

### BRIEF DESCRIPTION OF THE DRAWINGS

The present invention will become more fully understood from the detailed description given hereinbelow and the accompanying drawings which are given by way of illustration only, and thus are not intended to limit the present invention, and wherein:

FIG. 1A is a block diagram of a light-receiving circuit for obtaining a resolution which is twice the movement cycle of a movable member included in a first embodiment of the optical encoder according to the present invention;

FIG. 1B is a schematic diagram showing the optical system of the first embodiment;

FIG. 2 is a circuit diagram of a subtracter included in the first embodiment;

FIG. 3A is a circuit diagram of subtracters of a second embodiment of the optical encoder of the present invention;

FIG. 3B is a circuit diagram of adders of the second embodiment;

FIG. 4A is a circuit diagram of subtracters of a third embodiment of the optical encoder of the present invention;

FIG. 4B is a circuit diagram of adders of the third embodiment;

FIG. 5A is a circuit diagram of a comparator of a fourth embodiment of the optical encoder of the present invention;

FIG. 5B is a circuit diagram of another comparator of the fourth embodiment;

FIG. 6A is a circuit diagram of a comparator of a fifth embodiment of the optical encoder of the present invention;

FIG. 6B is a circuit diagram of another comparator of the fifth embodiment; and

FIG. 7 is a circuit diagram of an output circuit in the first to fifth embodiments.

### DETAILED DESCRIPTION OF THE PREFERRED EMBODIMENTS

The present invention will be described in detail below according to embodiments shown in the figures.

### First Embodiment

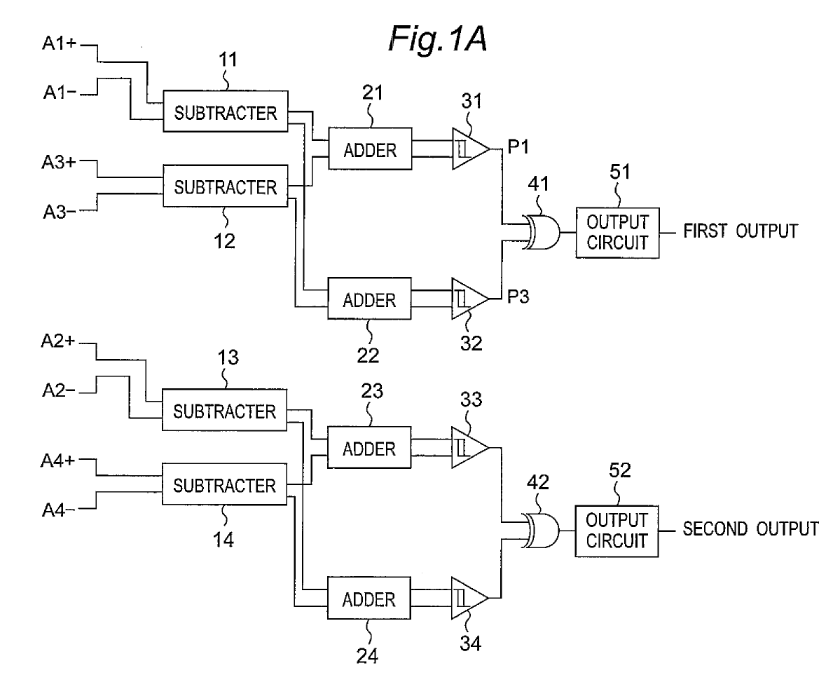

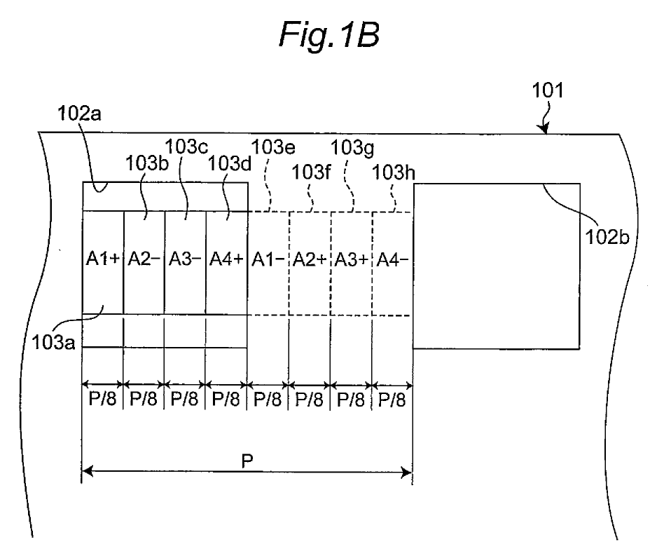

FIG. 1A is a representative block diagram of a light-receiving circuit included in a first embodiment of the optical encoder according to the present invention.

As shown in FIG. 1A, the light-receiving circuit constitutes a signal processing section and has subtracters 11 to 14 serving as the signal processing circuits, adders 21 to 24 serving as the arithmetic processing section, comparators 31 to 34 serving as the A/D converting section, exclusive-or circuits 41 and 42, and output circuits 51 and 52 as the digital signal section.

In FIG. 1A, A1+, A2+, A3+, A4+, A1−, A2−, A3−, and A4− are signals caused by photocurrents obtained from light-receiving elements, respectively, and are different in phase by 45 degrees.

FIG. 1B shows an example of an optical system by which the signals A1+, A2+, A3+, A4+, A1−, A2−, A3−, and A4− are obtained. The example shown in FIG. 1B has a movable member 101, eight photodiodes 103a to 103h for signal production serving as the light-receiving elements and arranged behind the movable member 101 in FIG. 1B, and a light-emitting element (not shown in the figure) arranged on the front side of the movable member 101 as viewed in FIG. 1B. The movable member 101 has a plurality of slits 102a, 102b, . . . as the light-on sections, which are provided with a predetermined pitch P in the direction of movement of the movable member 101 and each have a width equal to half the pitch P. A light-off section is provided between the slit 102a and the slit 102b.

In this optical encoder, light from the light-emitting element passes through the slits 102a and 102b and is detected by the eight photodiodes 103a to 103h. The light-emitting element usually consists of a single element so as to be a single light source. On the other hand, the eight photodiodes 103a to 103h each having a width which is one-eighth of the pitch P are provided as the light-receiving elements so as to be able to detect the directions and speed of movement of the movable member 101. The eight photodiodes 103a to 103h are arranged to be adjacent to each other in the direction of arrangement of the slits 102a and 102b with one-eighth the pitch P, namely with a pitch of P/8.

In this optical encoder, when the movable member 101 moves in either of the directions of movement, the signals A1+, A1−, A2+, A2−, A3+, A3−, A4+, and A4− caused by photocurrents are produced in the photodiodes 103a to 103h, respectively, as shown in FIG. 1A, according to changes with time in light-receiving area of the photodiodes 103a to 104h which receive light which has passed through the slits 102a and 102b and then applied to the photodiodes 103a to 103h.

The two signals A1+ and A1− which are different in phase by 180 degrees from each other are input to the subtracter 11. The two signals A3+ and A3− which are different in phase by 180 degrees from each other are input to the subtracter 12. The two signals A2+ and A2− which are different in phase by 180 degrees from each other are input to the subtracter 13. The two signals A4+ and A4− which are different in phase by 180 degrees from each other are input to the subtracter 14. As described later, each of the subtracters 11 to 14 has a comparison circuit.

The subtracter 11 makes a comparison (subtraction) between the signals A1+ and A1− to output a signal {(A1+)-(A1−)} to the adders 21 and 22. The subtracter 12 makes a comparison (subtraction) between the signals A3+ and A3− to output a signal {(A3+)−(A3−)} to the adder 21 and output a signal {(A3−)−(A3+)} to the adder 22. The subtracter 13 makes a comparison (subtraction) between the signals A2+ and A2− to output a signal {(A2+)−(A2−)} to the adders 23 and 24. The subtracter 14 makes a comparison (subtraction) between the signals A4+ and A4− to output a signal {(A4+)−(A4−)} to the adder 23 and output a signal {(A4−)−(A4+)} to the adder 24.

Two signals [}(A1+)−(A1−)}+{(A3+)−(A3−)}] and [−{(A1+)−(A1−)}−{(A3+)−(A3−)}] outputted from the adder 21 are input to the comparator 31, which performs A/D conversion on the basis of these two signals. Two signals [{(A1+)−(A1−)}+{(A3−)−(A3+)}] and [{(A1−)−(A1+)}+{(A3+)−(A3−)}] outputted from the adder 22 are input to the comparator 32, which performs A/D conversion on the basis of these two signals.

Two signals [{(A2+)−(A2−)}+{(A4+)−(A4−)}] and [−{(A2+)−(A2−)}+{(A4+)−(A4−)}] outputted from the adder 23 are input to the comparator 33, which performs A/D conversion on the basis of these two signals. Two signals [{(A2+)−(A2−)}+{(A4−)−(A4+)}] and [−{(A2+)−(A2−)}+{(A4+)−(A4−)}] outputted from the adder 24 are input to the comparator 34, which performs A/D conversion on the basis of these two signals.

The output signals of the comparators 31 and 32 are input to the exclusive-or circuit 41, the output signal of which is input to the output circuit 51. Furthermore, the output signals of the comparators 33 and 34 are input to the exclusive-or circuit 42, the output signal of which is input to the output circuit 52. Each of the output circuits 51 and 52 performs waveform shaping of an inputted signal to output an encoder signal.

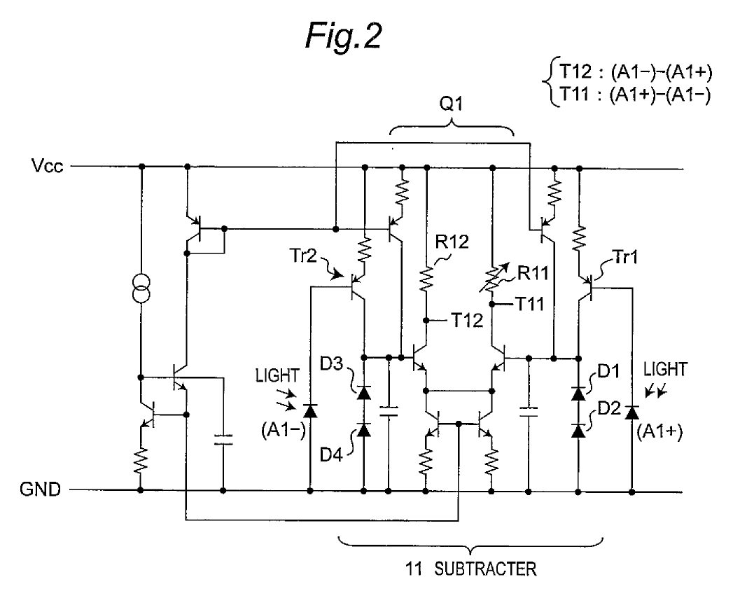

In the first embodiment, the subtracter 11 to which the signals A1+ and A1− are input has an adjustable resistor R11 as shown in FIG. 2. In the subtracter 11, the signals A1+ and A1− are amplified with a current amplification factor Hfe by the PNP transistor Tr1 and the PNP transistor Tr2, respectively. Logarithmic compressions of currents obtained by the amplifications are performed by the diodes D1 and D2 in two stages and the diodes D3 and D4 in two stages, respectively. Two signals obtained by the logarithmic compressions are input to the differential amplifier Q1 as the comparison circuit. Of the output resistors R11 and R12 of the differential amplifier Q1, the output resistor R11 is the adjustable resistor R11 the resistance value of which is adjustable. The differential amplifier Q1 outputs the signal {(A1+)−(A1−)} from its first output terminal T11 and outputs the signal {(A1−)−(A1+)} from its second output terminal T12. By adjusting the resistance value of the adjustable resistor R11, the DC offset of the signals {(A1+)−(A1−)} and {(A1−)−(A1+)} can be reduced. Because of this, even if the amplitudes of the two signals have been reduced by a reduction in SN ratio caused by a stain of the movable member 101 or the like, the two signals can be output as signal components to circuits in the subsequent stages because the offsets of the two signals have been reduced.

The first embodiment has been described in connection with the case in which of the four subtracters 11 to 14 as the signal processing circuits, the subtracter 11 has an adjustable resistor R11. However, the basic circuit configurations of the four subtracters 11 to 14 are similar, so that, alternatively, the subtracter 12 may have an adjustable resistor. Alternatively, each of the subtracters 11 and 12 may have an adjustable resistor, or at least one of the subtracters 13 and 14 may have an adjustable resistor.

### Second Embodiment

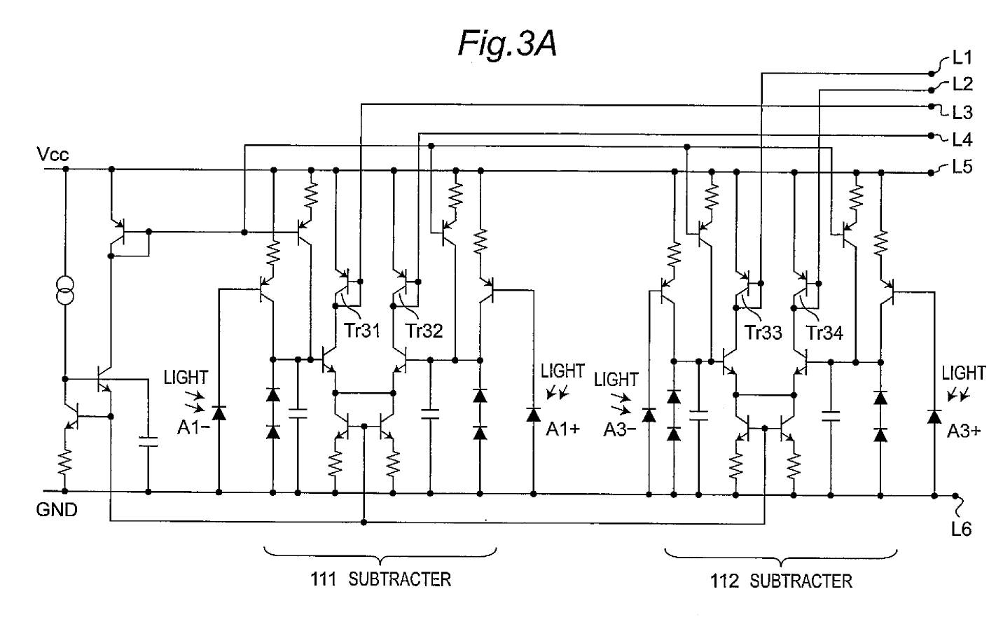

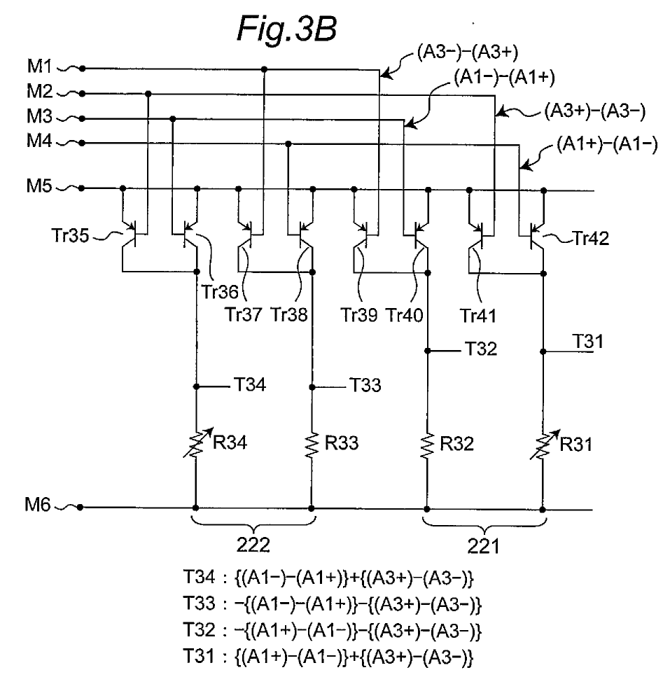

Next, a second embodiment of the optical encoder according to the present invention will be described with reference to FIGS. 3A and 3B. The second embodiment is different from the first embodiment in that the second embodiment has subtracters 111 to 114 having no adjustable resistor and adders 221 and 222 having adjustable resistors R31 and R34. For this reason, in the second embodiment, only points which are different from the first embodiment will be mainly described. L1 to L6 in FIG. 3A are connected to M1 to M6 in FIG. 3B, respectively.

In the second embodiment, as is apparent from FIG. 3A, the subtracters 111 and 112 corresponding to the subtracters 11 and 12 of the first embodiment have no adjustable resistor. Although the subtracters 11 and 12 of the first embodiment take out the output signals of the differential amplifiers as voltages using resistors, the subtracters 111 and 112 of the second embodiment have no adjustable resistor. Furthermore, the two remaining subtracters of the second embodiment, which are not shown in FIG. 3A, corresponding to the subtracters 13 and 14 of the first embodiment have circuit configurations similar to those of the subtracters 111 and 112.

In the second embodiment, the transistor Tr31 of the subtracter 111 shown in FIG. 3A constitutes a current mirror circuit in conjunction with the transistor Tr40 of the adder 221 and the transistor Tr36 of the adder 222 shown in FIG. 3B. Furthermore, the transistor Tr32 of the subtracter 111 constitutes a current mirror circuit in conjunction with the transistor Tr42 of the adder 221 and the transistor Tr38 of the adder 222. Furthermore, the transistor Tr33 of the subtracter 112 constitutes a current mirror circuit in conjunction with the transistor Tr39 of the adder 221 and the transistor Tr37 of the adder 222. Furthermore, the transistor Tr34 of the subtracter 112 constitutes a current mirror circuit in conjunction with the transistor Tr41 of the adder 221 and the transistor Tr35 of the adder 222.

In the adder 221, the transistors Tr41 and Tr42 output a current which is converted to a voltage by the resistor R31, and the transistors Tr39 and Tr40 output a current which is converted to a voltage by the resistor R32. In the adder 222, the transistors Tr37 and Tr38 output a current which is converted to a voltage by the resistor R33, and the transistors Tr35 and Tr36 output a current which is converted to a voltage by the resistor R34.

As a result of this, the adder 221 outputs a signal [{(A1+)−(A1−)}+{(A3+)−(A3−)}] from its output terminal T31, and outputs a signal [−{(A1+)−(A1−)}−{(A3+)−(A3−)}] from its output terminal T32.

In the adder 221, of the two output resistors R31 and R32, the output resistor R31 is an adjustable resistor of which the resistance value is adjustable, so that the offset of the two signals can be reduced. Thus, variations in the duty ratio of the output signal of the comparator 31 serving as the A/D converting section can be reduced, and thereby an accurate and stable encoder operation is achieved.

Furthermore, the adder 222 outputs a signal [−{(A1−)−(A1+)}−{(A3+)−(A3−)}] from its output terminal T33, and outputs a signal [{(A1−)−(A1+)}+{(A3+)−(A3−)}] from its output terminal T34. In the adder 222, of the two output resistors R33 and R34, the output resistor R34 is an adjustable resistor of which the resistance value is adjustable, so that the offset of the two signals can be reduced. Thus, variations in the duty ratio of the output signal of the comparator 32 serving as the A/D converting section can be reduced, and thereby an accurate and stable encoder operation is achieved.

The second embodiment includes two adders corresponding to the adders 23 and 24 of the first embodiment, and these two adders have circuit configurations similar to those of the two adders 221 and 222 shown in FIG. 3B.

### Third Embodiment

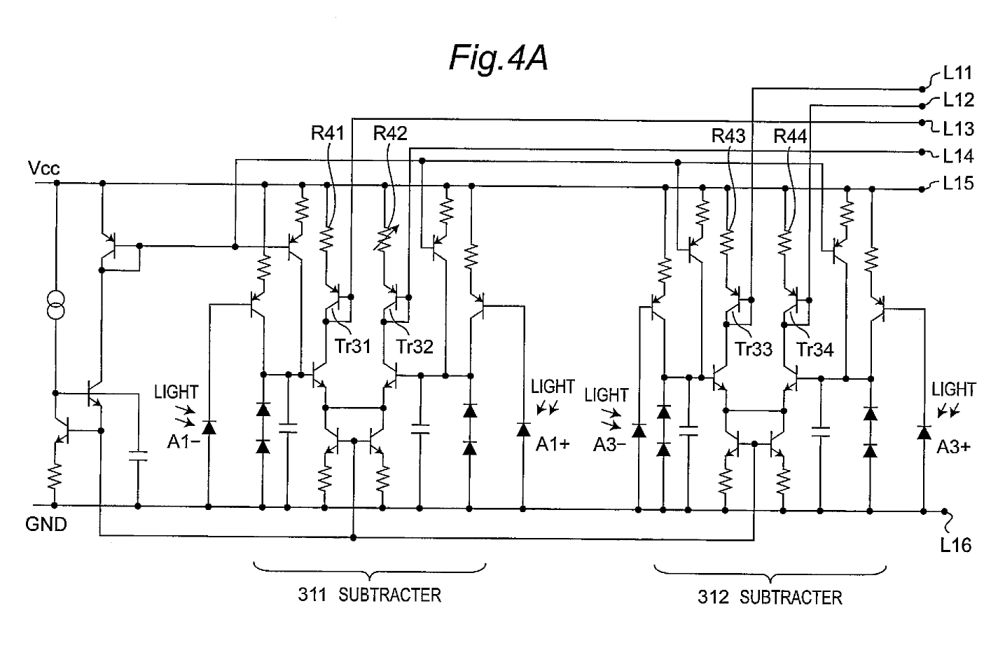

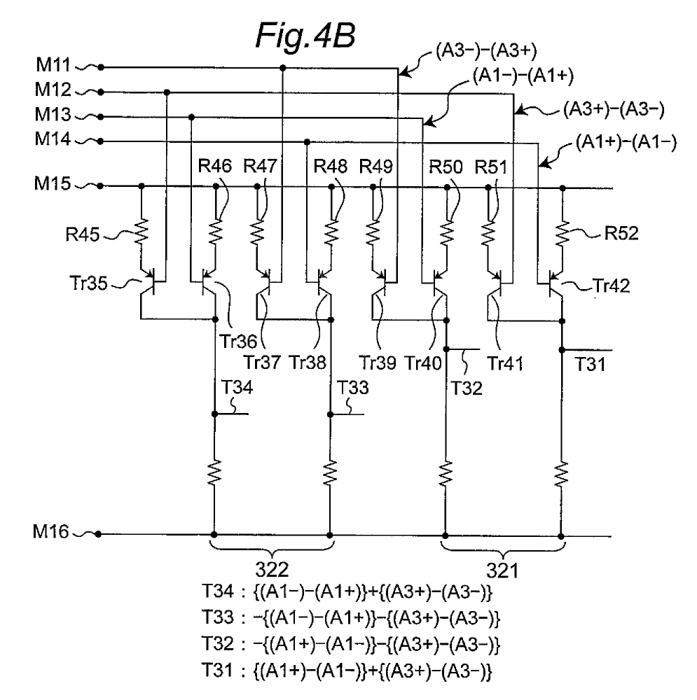

Next, a third embodiment of the optical encoder according to the present invention will be described with reference to FIGS. 4A and 4B. The third embodiment is different from the second embodiment in that the third embodiment has subtracters 311 and 312 and adders 321 and 322 instead of the subtracters 111 and 112 and the adders 221 and 222 shown in FIGS. 3A and 3B. For this reason, in the third embodiment, only points which are different from the second embodiment will be mainly described. L11 to L16 in FIG. 4A are connected to M11 to M16 in FIG. 4B, respectively.

As shown in FIG. 4A, in the subtracter 311, resistors R41 and R42 are connected with the emitters of the transistors Tr31 and Tr32 of a current mirror circuit, and the resistor R42 is an adjustable resistor the resistance value of which is adjustable. Furthermore, in the subtracter 312, resistors R43 and R44 are connected with the emitters of the transistors Tr33 and Tr34 of a current mirror circuit.

On the other hand, as shown in FIG. 4B, in the adder 322, resistors R45 and R46 are connected with the emitters of the transistors Tr35 and Tr36 of a current mirror circuit, and resistors R47 and R48 are connected with the emitters of the transistors Tr37 and Tr38 of a current mirror circuit. Furthermore, in the adder 321, resistors R49 and R50 are connected with the emitters of the transistors Tr39 and Tr40 of a current mirror circuit, and resistors R51 and R52 are connected with the emitters of the transistors Tr41 and Tr42 of a current mirror circuit.

In the third embodiment, of the subtracters 311 and 312 and the adders 321 and 322, only the subtracter 311 has an adjustable resistor R42. In other words, in the third embodiment, the subtracter 311 in a stage before the adders 321 and 322 has one adjustable resistor R42 instead of the adjustable resistors R31 and R34 included in the adders 221 and 222 of the second embodiment. For this reason, according to the third embodiment, the number of adjustable resistors can be reduced as compared with the second embodiment.

### Fourth Embodiment

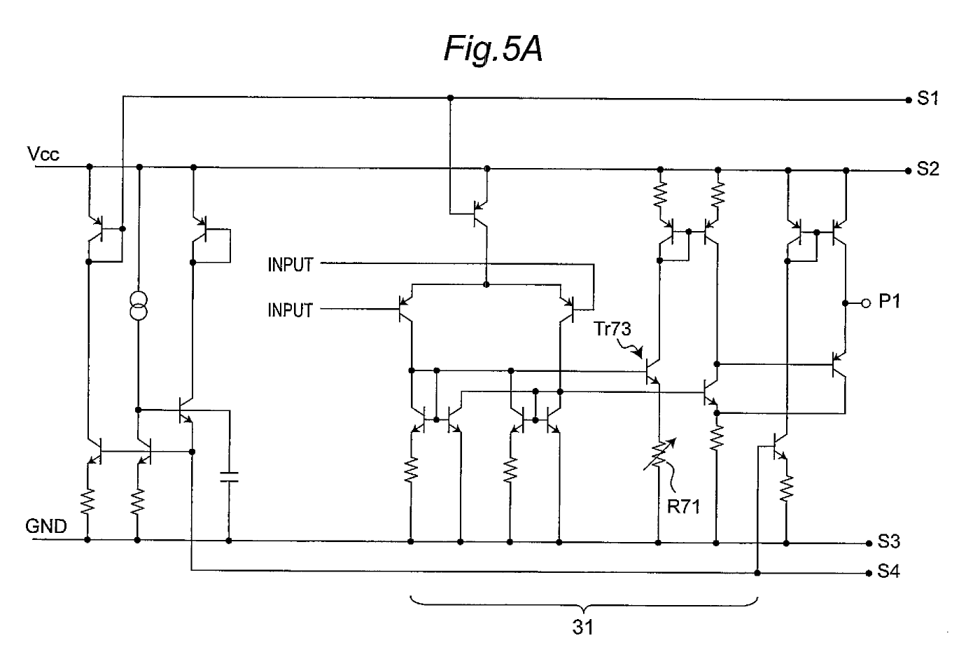

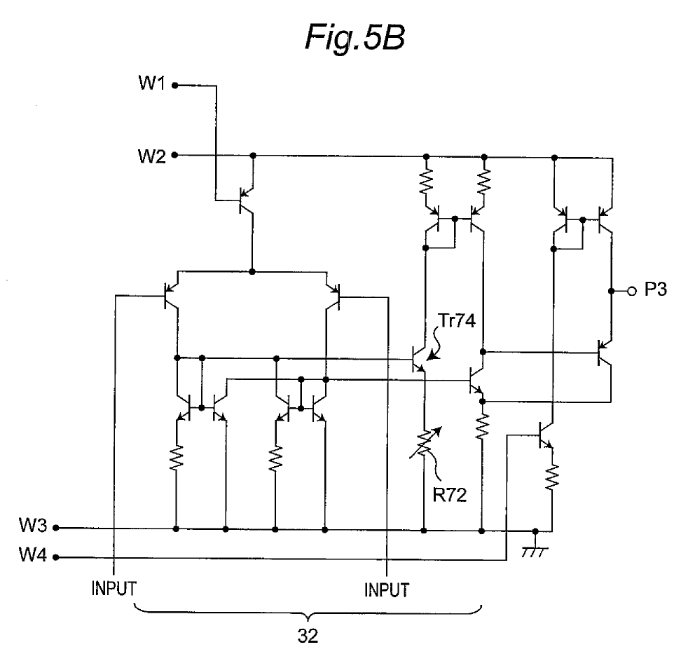

Next, a fourth embodiment of the optical encoder according to the present invention will be described with reference to FIGS. 5A and 5B. The fourth embodiment is different from the first embodiment in that as shown in FIGS. 5A and 5B, the comparators 31 and 32 serving as the A/D converting section in FIG. 1A have respective adjustable resistors R71 and R72 the resistance values of which are adjustable. For this reason, in the fourth embodiment, only points which are different from the first embodiment will be mainly described. S1, S2, S3, and S4 in FIG. 5A are connected with W1, W2, W3, and W4 in FIG. 5B, respectively.

In the fourth embodiment, as shown in FIG. 5A, the emitter resistor R71 of the transistor Tr73 constituting the output section of the comparator 31 is an adjustable resistor. Furthermore, in the fourth embodiment, as shown in FIG. 5B, the emitter resistor R72 of the transistor Tr74 constituting the output section of the comparator 32 is an adjustable resistor.

In the fourth embodiment, the emitter resistors of the transistors TR73 and TR74 which switch on and off in the output sections of the comparators 31 and 32 are adjustable, so that the differences between the on-times and the off-times can be adjusted, and thereby the duty ratios of output signals can be brought near to an ideal state.

Also in the comparators 33 and 34, the emitter resistors of the transistors of the output sections are adjustable as in the comparators 31 and 32, so that the differences between the on-times and the off-times can be adjusted, and thereby the duty ratios of output signals can be brought near to an ideal state.

### Fifth Embodiment

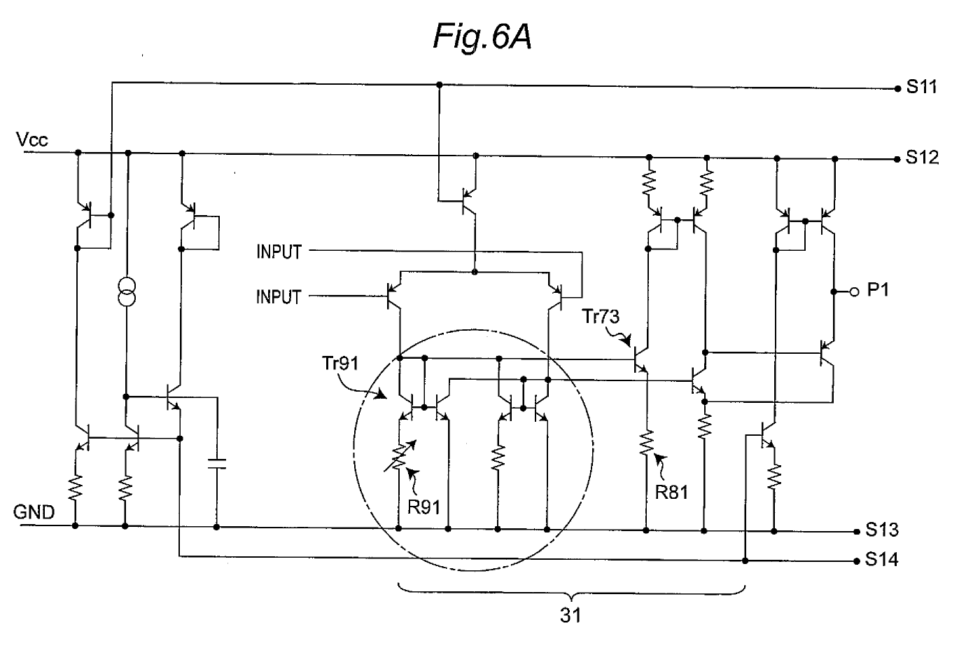

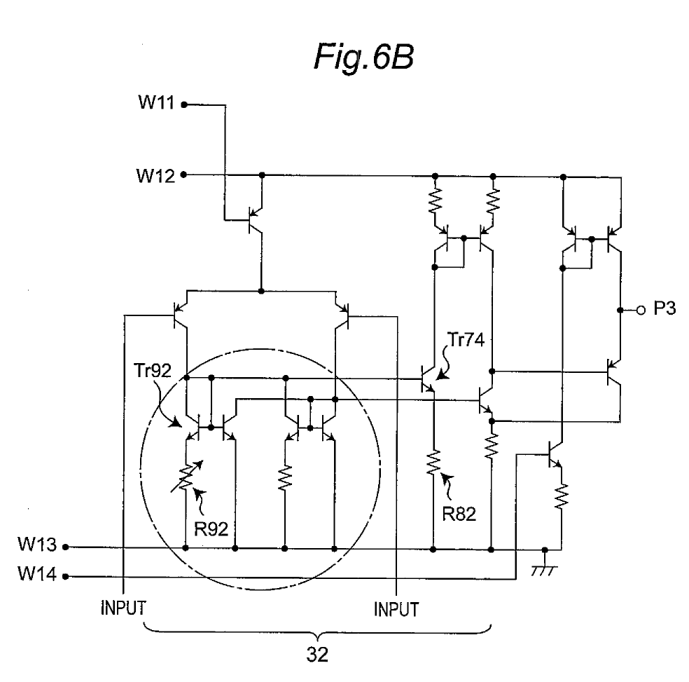

Next, a fifth embodiment of the optical encoder according to the present invention will be described with reference to FIGS. 6A and 6B. The fifth embodiment is different from the fourth embodiment in that the fifth embodiment includes resistors R81 and R82 which are not adjustable resistors, instead of the adjustable resistors R71 and R72 in FIGS. 5A and 5B, and the fifth embodiment also includes adjustable resistors R91 and R92 the resistance values of which are adjustable, in hysteresis producing areas surrounded with alternate long and short dash lines in FIGS. 6A and 6B. S11, S12, S13, and S14 in FIG. 6A are connected with W11, W12, W13, and W14 in FIG. 6B, respectively.

In the fifth embodiment, the resistance values of the adjustable resistors R91 and R92 in the hysteresis producing areas of the comparators 31 and 32 are adjusted, so that the saturation states of the transistors Tr91 and Tr92 vary, and thereby the hysteresis widths can be adjusted. As a result of this, the duty ratios of digital signals, which are comparator output signals, can be adjusted, and therefore the duty ratios of the digital signals are prevented from deviating from an ideal state when an offset has occurred in the optical system or the circuit system.

Not only the comparators 31 and 32 but also the comparators 33 and 34 include resistance-adjustable resistors in their respective hysteresis producing areas, so that the saturation states of the transistors vary, and therefore the hysteresis widths of the comparators can be adjusted.

(Example of Output Circuit)

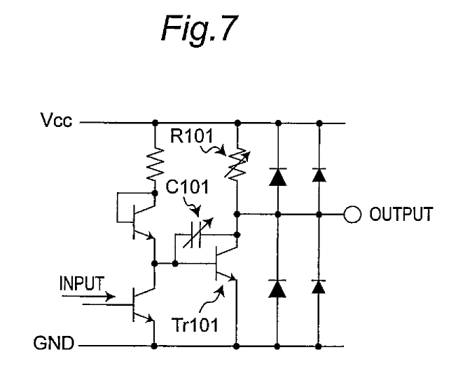

Next, an example of the output circuits 51 and 52 as the digital signal section for processing digital signals in the first to fifth embodiments of the optical encoder according to the present invention will be described below with reference to FIG. 7. This output circuit is a circuit adapted to shape the waveform of an inputted digital signal and output it, as is apparent from FIG. 7. In this output circuit, an adjustable capacitance C101 and an adjustable resistor R101 are connected with a transistor Tr101 which switches on and off. Only one of the adjustable capacitance C101 and the adjustable resistor R101 may be provided.

In this output circuit, the rise time, tr, and fall time, tf, of a digital signal can be adjusted with the adjustable capacitance C101 and the adjustable resistor R101, and thereby the duty ratio of the digital signal can be adjusted and variations in the duty ratio of the digital signal can be reduced.

In the exclusive-or circuits 41 and 42 which are logical operation sections in FIG. 1, an adjustable capacitance and an adjustable resistor may be connected to a transistor which switches on and off, as in the above output circuit. In this case as well, the duty ratio of a digital signal can be adjusted as described above.

Furthermore, electronic equipment including an optical encoder according to any one of the above embodiments is able to have an increased operation accuracy because of the steady optical encoder which has an excellent operational accuracy and few variations in the output signal even when the amount of received light varies.

Embodiments of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An optical encoder, comprising:
a light-emitting element;
a plurality of light-receiving elements arranged in one direction in an area where light from the light-emitting element is able to reach the light-receiving elements;
a movable member which has a light-on section allowing the light to enter the light-receiving elements when passing through predetermined positions corresponding to the light-receiving elements, and a light-off section not allowing the light to enter the light-receiving elements when passing through the predetermined positions corresponding the light receiving elements, wherein the light-on section and the light-off section pass through the predetermined positions alternately when the movable member moves in the one direction;
a signal processing section to which signals outputted from the plurality of light-receiving elements are input and which includes a comparison circuit for comparing two of a plurality of signals obtained from the inputted signals, said two signals being different in phase by 180 degrees from each other; and
at least one adjustable resistor for adjusting a potential of an output signal of the comparison circuit or a potential of a signal obtained from the output signal of the comparison circuit.

2. An optical encoder as claimed in claim 1, wherein:
the signal processing section comprises n signal processing circuits, wherein n is an integer of 2 or more,
the optical encoder further comprises an arithmetic processing section to which n output signals from the n signal processing circuits are input and which performs arithmetic processing on the n output signals, and
the arithmetic processing section includes the adjustable resistor.

3. An optical encoder as claimed in claim 1, wherein the signal processing section includes the adjustable resistor.

4. An optical encoder as claimed in claim 2, further comprising an A/D converting section for A/D converting an output signal of the arithmetic processing section, the A/D converting section including an adjustable resistor for adjusting a duty ratio.

5. An optical encoder as claimed in claim 2, further comprising an A/D converting section for A/D converting an output signal of the arithmetic processing section, the A/D converting section including an adjustable resistor for adjusting a hysteresis width.

6. An optical encoder as claimed in claim 2, further comprising a digital signal section for processing a digital signal obtained from an output signal of the arithmetic processing section, the digital signal section including at least one of an adjustable resistor or an adjustable capacitance for adjusting at least one of a rise time or a fall time of the digital signal.

7. Electronic equipment comprising an optical encoder as claimed in claim 1.
